(19) United States
(12) Patent Application Publication
(10) Pub. No.: US 2024/0358037 A1
(43) Pub. Date: Oct. 31, 2024

(54) CONTAINER TO PRODUCE SLUSH DRINKS

(71) Applicant: Baruch TZIMER, Kfar Mordechai (IL)

(72) Inventor: Baruch TZIMER, Kfar Mordechai (IL)

(21) Appl. No.: 18/691,951

(22) PCT Filed: Sep. 14, 2022
(86) PCT No.: PCT/IB2022/058647

§ 371 Date: Mar. 14, 2024

Related U.S. Application Data
(60) Provisional application No. 63/243,771, filed on Sep. 14, 2021.

(51) Int. Cl. A23G 9/12; A23G 9/04; A23G 9/22

(52) U.S. Cl. CPC A23G 9/12; A23G 9/045; A23G 9/224; A23G 9/228

(57) ABSTRACT

A device for agitating a content of a container comprising a container, a cap, and an agitator, the container comprising an enclosure surrounding interior cavity, the enclosure comprising a mouth opening providing access to the cavity. The cap is removably attachable to the mouth, and the cap comprising a sealing mechanism adapted to seal liquids within the container. The agitator comprising an axle extending from the mouth into the cavity of the container. at least one blade attached to the axle for agitating a content of the container when the agitator is rotated, and a rotation mechanism for rotating the axle relative to the container.

### CROSS-REFERENCE TO RELATED APPLICATIONS

This application claims priority from U.S. Provisional Patent Application No. 63/243,771, filed Sep. 14, 2021, whose disclosure is incorporated by reference in its entirety herein.

### TECHNICAL FIELD

The present invention is directed to a container equipped for the production of slushy ice drinks.

### BACKGROUND OF THE INVENTION

A slushy, or slushie, or slush, is a type of flavored ice beverage with a semi-liquid consistency. A slushy is produced by cooling a beverage to freezing temperature while agitating the beverage to prevent ice crystals from forming a solid mass.

Slush is made from a solution of sugar and water. To prevent the solution from freezing solid, sugar is present. The sugar acts as an antifreeze in the solution. Additionally, a slush machine may stir, mix, agitate, and/or rotate the solution thereby constantly exchanging the solution closest to a refrigeration element of the slush machine so that the sugar and water molecules bond together before the water freezes, and the agitation prevents ice crystals from forming. The result is a soft, wet slurry mixture, referred to herein as a slushy, that may be below the temperature of ice. The physical state of a slushy may be referred to herein as a “semi-liquid” and/or a “slurry”. FIG. 5a is a picture of a slushy drink for illustrative purposes only.

Producing a slushy is traditionally performed by countertop slushy requiring a connection to an AC electrical outlet. FIG. 5b is an illustration of a counter-top machine for making a slushy for illustrative purposes only.

Once the slushy is dispensed from the slushy machine, over time the ambient temperature may melt the slushy into mostly or entirely liquid form. The availability of a slushy is therefore limited to the proximity of an expensive electrical machine. Consumption of a slushy at a location remote from a slushy machine, for example at home, or while traveling, may be restricted due to the above and other constraints.

The purpose of the present invention is to provide a solution to the abovementioned problems.

### SUMMARY OF THE INVENTION

Embodiments of the invention are directed to a device for agitating a content of a container comprising a container, a cap, and an agitator, the container comprising an enclosure surrounding interior cavity, the enclosure comprising a mouth opening providing access to the cavity, the cap removably attachable to the mouth, the cap comprising a sealing mechanism adapted to seal liquids within the container, the agitator comprising an axle extending from the mouth into the cavity of the container, at least one blade attached to the axle for agitating a content of the container when the agitator is rotated, and a rotation mechanism for rotating the axle relative to the container.

Optionally the device is such that the coupling mechanism is allowing the blades to move between an extended state wherein the at least one blades extends radially from the axle towards an outer side of the interior of the container, and a retracted state, wherein the at least one blade retracts away from the outer side and towards the axle.

Optionally the device is such that a maximum cross-section of the at least one blade and the axle when the blade is in the retracted state is less than an interior cross-section of the mouth, thereby allowing the agitator to pass within the mouth.

Optionally the device is such that a blade has a protrusion when in the retracted state, such that rotation of the at least one blade will at agitate at least a portion of the content of the container, whereupon the content will exert a force onto the at least one blade in a direction opposite to the rotation.

Optionally the device is such that a mechanism exerts a force to push the at least one blade to the retracted position, and a mechanism that extends the at least one blade towards the extracted position.

Optionally the device is such that the at least one blade, when in the extended state and rotating, is in contact with the interior of the container.

Optionally the device is such that a programmable control unit is adapted to control operation of the rotation of the agitator,

Optionally the device is such that it comprises a user interface for inputting instructions, a computing unit for storing and executing the instructions, an alerting unit, a computing unit for controlling rotation of the axle, and sensors for detecting physical phenomena of at least one member of a group comprising the agitator, the container, and the contents,

Optionally the device is such that at least one sensor is adapted to detect at least one member of a group physical phenomena comprising: temperature of the contents, force of resistance of the content to rotation of the at least one blade, speed of the rotation, and amount of time of the rotation, the at least one sensor adapted to transmit an encoded signal representing the detected physical phenomena to the computing unit.

Optionally the device is such that it comprises at least one user-selectable program comprising a plurality of instructions to the computing unit to control the rotation of the program instructions responsive to the transmitted encoded signal.

Optionally the device is such that it further comprising a battery connected to an electrical motor, the motor adapted to rotate the axle.

Embodiments of the invention are directed to a method for producing a slushy in a portable container comprising placing a slurry solution into a container, inserting an agitator with at least one blade into a cavity of the container, sealing the container with a cap, exposing the solution to freezing temperature, and rotating the agitator.

Optionally the method is such that agitator is inserted into the container by retracting the at least one blade towards an axle of the agitator, and agitating the container contents by extending the at least one blade towards an interior wall of the container.

Optionally the method is such that rotating the at least one blade is in a retracted state, whereby a protrusion of the blades interacting with the content of the container exerts a force on the at least one blade in a direction opposite to the rotation.

Optionally the method comprises retracting and extending the at least one blade by a force generated by a mechanism attached to the blades.

Optionally the method comprises when rotating the agitator, scraping an interior surface of the container by a surface of the at least one blade.

Optionally the method comprises controlling the rotation of the agitator by inputting instructions to a control unit of the device, the control unit alerting a user of a state of operation of the device.

Optionally the method comprises controlling the operation of the agitator responsive to sensing at least one physical phenomena selected from a group comprising: temperature of the contents, force of resistance of the content to rotation of the at least one blade, speed of the rotation, and amount of time of the rotation.

Optionally the method comprises controlling the operation of the agitator responsive to sets of user-selectable programs.

This document references terms that may be used consistently and/or interchangeably herein. These terms, including variations thereof, are as follows: state, position. All references to “blade” and/or “blades” refers to at least one blade.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a block diagram of a slushy maker, according to embodiments of the present invention;

FIG. 2a is a schematic illustration of a side cut-away view of a slushy maker, according to embodiments of the present invention;

FIG. 2b is a schematic illustration of a top view cross section of a slushy maker, according to embodiments of the present invention;

FIG. 3a is a schematic illustration of a side cut-away view of a slushy maker, according to embodiments of the present invention;

FIG. 3b is a schematic illustration of a top view cross section of a slushy maker with retracted blades, according to embodiments of the present invention;

FIG. 3c is a schematic illustration of a top view cross section of an axle with extended blades, according to embodiments of the present invention;

FIG. 4 is a diagram of a flow chart of a method for making a slushy using a slushy maker, according to embodiments of the present invention;

FIG. 5a is a picture of a prior art slushy drink;

FIG. 5b is an illustration of a prior art counter-top machine for making a slushy;

FIG. 6 is a block diagram of a slushy maker control unit;

FIG. 7 is a schematic illustration of a side view cross section of a slushy maker with extended blades, according to embodiments of the present invention;

FIG. 8 is a schematic illustration of a transparent side view of a slushy maker with extended blades, according to embodiments of the present invention;

FIG. 9 is a schematic illustration of an outline side view of a slushy maker with extended blades, according to embodiments of the present invention; and

FIG. 10 is a schematic illustration of a top view cross section of a slushy maker with extended blades, according to embodiments of the present invention.

### DESCRIPTION OF THE PREFERRED EMBODIMENTS

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

As will be appreciated by one skilled in the art, aspects of the present invention may be embodied as a system, device, method and/or computer controlled product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “phase”, “module”, “unit”, or “system.” Furthermore, aspects of the present invention may take the form of a computer program product embodied in one or more non-transitory computer readable (storage) medium(s) having computer readable program code embodied thereon.

In all places the phrase “blades” refers to at least one blade, not necessarily to a plurality of blades.

In some embodiments, the current invention, referred to as “slushy maker”, may be a portable unit and/or container capable of producing a slushy. The slushy maker may comprise a container, a cap, and an agitator. When a liquid suitable for production of a slushy drink is within the container, the cap may seal the liquid within the contain, and blades of the agitator may rotate within the liquid while a refrigeration unit cools the liquid to freezing temperature or below, thereby over time producing a slushy drink.

In certain non-limiting embodiments, the slushy maker may be placed in a sub-zero environment, for example the freezer compartment of a home refrigerator. In some embodiments, the slushy maker comprises a refrigeration and/or thermal storage unit to allow production of a slushy in a non-freezing environment.

In certain non-limiting embodiments, the slushy maker may include a control unit comprising a computer and control circuits which allows a user to input instructions for operation of the agitator. For example, the instructions may include programs comprising sets of instructions pre-programmed within a memory unit and/or input by a user, which cause the agitator to stop and/or start operation in response to physical attributes of the liquid, for example temperature, viscosity, and or time. The control unit may allow a user to “fire and forget”, i.e. to turn on the slushy maker and the slushy maker may automatically turn off and/or change speed of rotation, and alert the user that the slushy is ready.

In certain non-limiting embodiments, the agitation unit may include a motor and power source to rotate the agitator blades.

In certain non-limiting embodiments, the agitator blades may be mounted on an axle of the agitator that may extend through a mouth, which may be referred to herein as a “mouth opening”, of the container into a cavity of the container. The blades may be mounted onto the axle in a manner that allows the blades to extend outward from the axle toward and/or contacting the interior wall of the container, and additionally may allow the blades to retract towards the axle. The retraction of the blades may allow the agitator to be extracted through the mouth opening of the container, which may be narrower than the extended blades.

In certain non-limiting embodiments, the agitator may be removably mounted on an interior surface of the container, for example a bottom surface and extend upwards towards a mouth opening of the container.

The terms “slushy, “slushie”, and “slush” are used interchangeably throughout this description. The terms “slushy maker”, “slushie maker”, and “slush maker” are used interchangeably throughout this description.

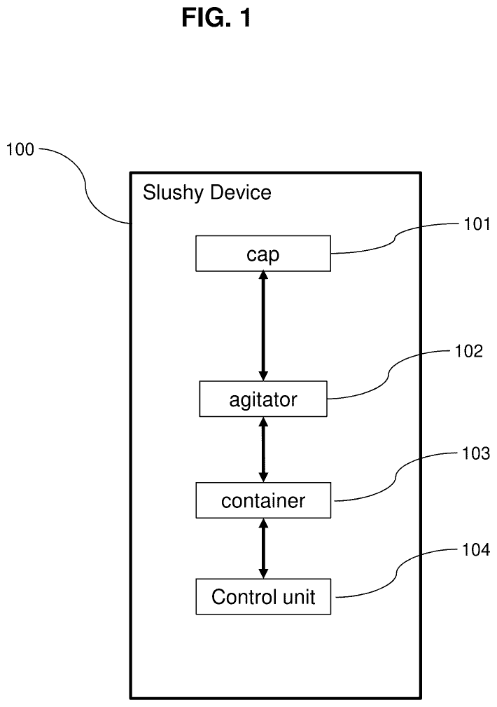

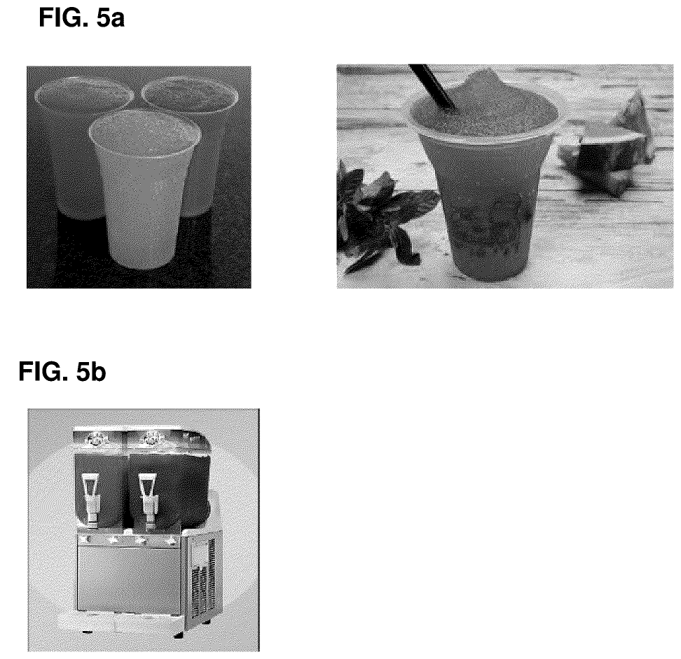

FIG. 1 is a block diagram slushy maker 100, which may be used to produce a slushy (for example the slushy or slushies illustrated in FIG. 5a), according to an embodiment of the present invention. Slushy maker 100 may include a cap 101, an agitator 102, and a container 103. In certain non-limiting embodiments, the slushy maker may further comprise a control unit 104.

In some embodiments, the agitator 102 may be connected to cap 101 and/or integrated with the cap 101. In some embodiments agitator 102 is independent of the cap and may be removably attached to the container, for example removably attached to a mouth opening of the container. In certain non-limiting embodiments, the agitator may be fixedly attached to the container, with a passageway allowing liquid and/or slushy to enter and/or exit the container. In certain non-limiting embodiments, a motor and/or a power supply configured to rotate the agitator may be integrated with the cap, agitator, and/or container.

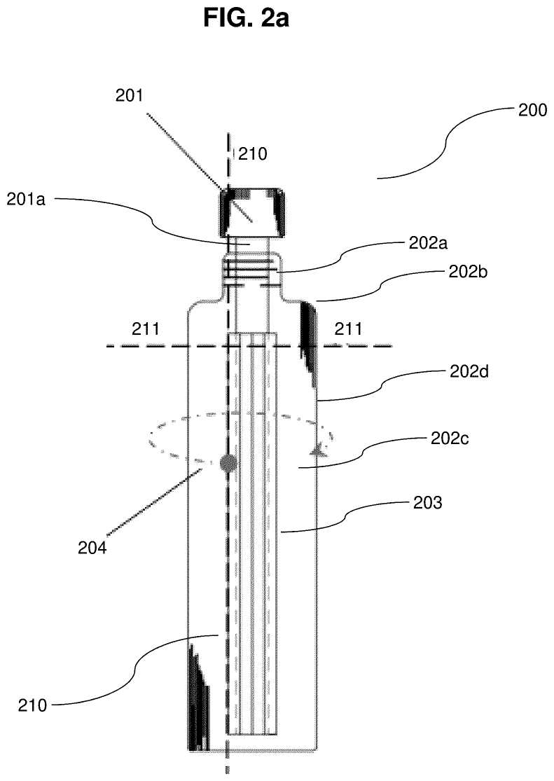

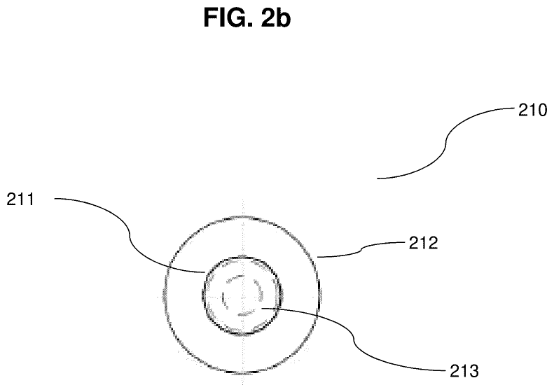

FIG. 2a is a schematic illustration of a side cut-away view of a slushy maker 200, according to certain embodiments of the present invention.

In some embodiments slushy maker 200 may comprise cap 201, which may be connected to agitator 203 which may extend into an interior cavity 202c of container 202b. In certain non-limiting embodiments, connecting piece 201a may connect between cap 201 and agitator 203. Container 202b may comprise an enclosure 202d surrounding interior cavity 202c, with an interior of said enclosure defining the confines of interior cavity 202c.

In certain non-limiting embodiments, a mouth opening 202a of container 202b may comprise, in conjunction with cap 201, a sealing mechanism allowing cap 201 to seal liquids within container 202b. See FIG. 7.

In certain non-limiting embodiments, an interior and/or exterior surface of cap 201 may be removably attachable (not shown) to mouth opening 202a, for example to an exterior and/or interior surface of mouth 202a.

In certain non-limiting embodiments slotted curved line 204 represents a direction of rotation of agitator 203. In certain non-limiting embodiments agitator may be rotated in the direction of line 204 and/or an opposite direction.

In certain non-limiting embodiments, slotted line 211 represents a vertical axis of slushy maker 200, and slotted line 210 represents a horizontal axis of slushy maker 200.

In certain non-limiting embodiments, container 202b may comprise a cylindrical body defining cavity 202c, and/or a cylindrical mouth opening 202a. In certain non-limiting embodiments mouth opening 202a defines an uppermost portion of container 202b. In certain non-limiting embodiments, a bottom portion of container 202b is flat and parallel to horizontal axis 211. In certain non-limiting embodiments, one or more vertical sides of container 202b may be substantially flat, allowing resting in a horizontal position.

In certain non-limiting embodiments mouth opening 202a may have an interior cylindrical shape and a non-cylindrical exterior shape. In certain non-limiting embodiments mouth opening 202a may have an exterior cylindrical shape and a non-cylindrical interior shape.

FIG. 2b is a schematic illustration of a top view cross section of a slushy maker, according to certain embodiments of the present invention.

In some embodiments slushy maker 210 may comprise cap 211, and container 212. Curved lines 213 represent a possible direction of rotation of an agitator (not shown).

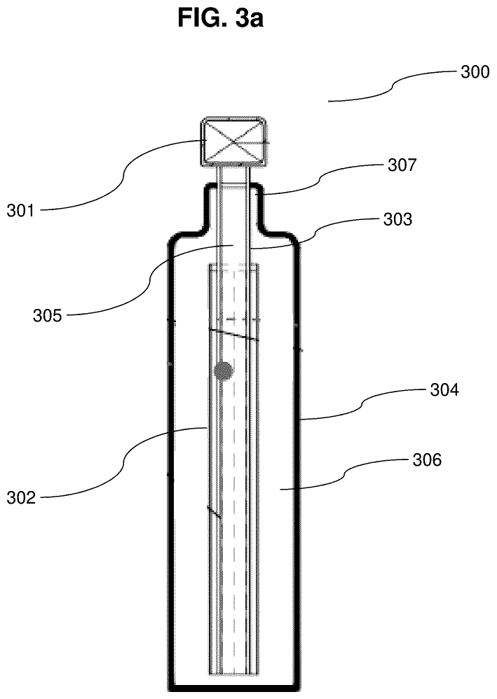

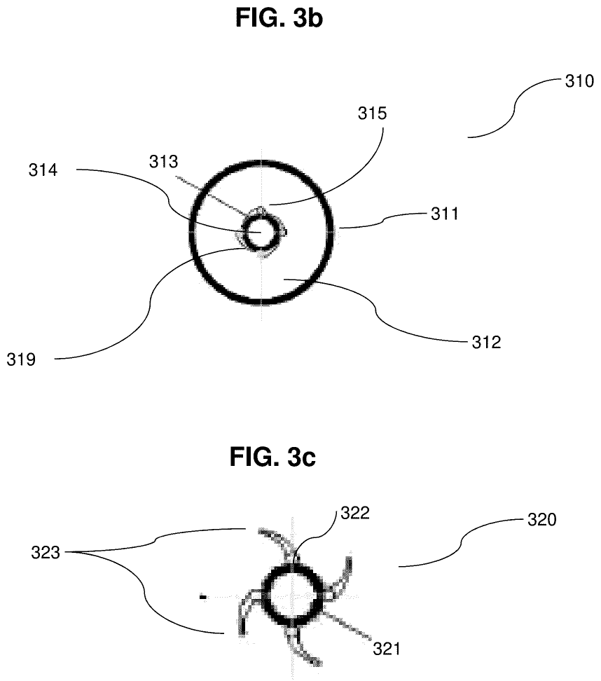

FIG. 3a is a schematic illustration of a side cut-away view of a slushy maker 310, according to some embodiments of the current invention.

In some embodiments slushy maker 300 may comprise a rotation mechanism (see FIG. 7), for example an electric motor, for rotating agitator 303 and/or axle 305 relative to container 304. For example, the electric motor may be integrated within cap 301, container 304, and/or an additional component of the slushy maker (not shown). In certain non-limiting embodiments, the motor may comprise and/or be connected to a power source, for example a battery. In certain non-limiting embodiments, slushy maker 300 may comprise a socket to receive electric power from an external power source to power the motor and/or to recharge the batteries (not shown). In certain non-limiting embodiments, the batteries are replaceable.

Alternatively or additionally, in certain non-limiting embodiments slushy maker 300 may comprise a hand powered rotation mechanism (not shown) for rotation of agitator 303.

In certain non-limiting embodiments, agitator 303 may comprise axle 305 and blades 302. Agitator 303 may extend downwards from cap 301 via mouth opening 307 into interior cavity 306. Axle 305 may extend from mouth opening 307 into interior cavity 306.

In certain non-limiting embodiments, agitator 303 may extend upwards from interior cavity 306 towards mouth opening 307.

In certain non-limiting embodiments, blades 302 may extend towards container 304.

In certain non-limiting embodiments, blades 302 may extend from a proximity to mouth opening 307 through container 304 to a proximity to a bottom or base of container 304.

FIG. 3b is a schematic illustration of a top view cross section of a slushy maker 310 with retracted blades, according to some embodiments of the current invention.

In some embodiments slushy maker 310 may comprise an axle 314 within the interior cavity 312 of container 311, wherein a set of one or more blades 313 may be attached to axle 314, for example by a coupling mechanism 315.

In certain non-limiting embodiments, coupling mechanism 315 may be any type of hinge, axle, pin, spindle, flexible substance, ball and socket, male and corresponding female threaded pieces, strap, and/or any other type of connector that allows each of the blades 313 to move between a retracted state in which at least one of blades 313 may be retracted towards and/or touching axle 314, and an extended state in which at least one of the blades 313 may be extended radially from axle 314 towards and/or touching interior wall of container 311 and/or the exterior wall of interior cavity 312

In certain non-limiting embodiments, coupling mechanism 315 may comprise an axis of movement of blades 313 parallel to axle 314, whereby movement of blades 313 between retracted and extended states includes movement substantially within a plane perpendicular to axle 314.

In certain non-limiting embodiments, coupling mechanism 315 may comprise an axis of movement of blades 313 that is perpendicular to axle 314, whereby movement of blades 313 between retracted and extended states includes movement substantially within a plane parallel to axle 314, i.e., in the retracted state blades 313 may fold downwards towards axle 314, and when moved to the extended state blades 313 may fold upwards away from axle 314.

In certain non-limiting embodiments, coupling mechanism 315 may comprise an axis of movement of blades 313 relative to axle 314 that is defines an angle between parallel and perpendicular to axle 314.

### Movement of Blades Between Retracted and Extended States

In certain non-limiting embodiments, a maximum cross-section of retracted at least one blades 313 may be less than an interior cross-section of mouth opening of container 311 (not shown), thereby allowing removal of blades 313 from container 311.

In certain non-limiting embodiments, coupling mechanism 315, another mechanism, and/or source of force may exert a mechanical force that pushes blades 313 towards the retracted state, such that a default position for blades 313 may be the retracted state. This mechanism may allow extraction of axle 314 from container 311. In certain non-limiting embodiments, the force may be exerted by a spring or any other mechanical means to exert a force on the blades towards the retracted state.

In certain non-limiting embodiments, when blades 313 move vertically between the retracted and extended states, the mechanical force may be partially or fully provided by gravity.

In certain non-limiting embodiments the mechanical force may be sufficient to retract blades 313 when container 311 is full of slush, but not so great as to prevent movement of blades 313 from the retracted state to the extended state as a result of a force from a content of container 311 when blades 313 are rotated, as described below.

In certain non-limiting embodiments, a portion 319 of one or more of the blades 313 may protrude outwards from axle 314 when the blades 313 are in the retracted state. When axle 314 is rotated the outward protrusion 319 would be pushed through a liquid or semi-liquid content of container 311, and the force exerted on blades 313 would be in an opposite direction to the rotation, thereby overcoming the mechanical force described above and thereby extending blades 313 from a retracted to an extended state.

In certain non-limiting embodiments blades 313 may experience an upward force when rotated within a content of container 311, the force the equal and opposite force resulting from of a slant or angled blade face that exerts a downwards force on a liquid and/or semi-liquid content of container 311. For example, an upper portion of blade 313 may be slanted forward in a direction of rotation relative to a lower portion of blade 313.

In some embodiments, the upward force may move blades 313 from the retracted to the extended state, for example when coupling mechanism 315 may comprise an axis of movement of blades 313 in a plane that is parallel to axle 314 as described above.

In certain non-limiting embodiments, the movement of blades between the extended state and the retracted state may be accomplished by a motor or other mechanical means.

In certain non-limiting embodiments, the blades 313, when extended, may extend to an interior wall of container 311,

In certain non-limiting embodiments blades 313 may be formed from a flexible and/or semi-flexible material, for example plastic, silicon, rubber and/or any combination thereof and/or any similar material, such that when extended and rotating, blades 313 may scrape the interior walls of container 311. In certain non-limiting embodiments blades 311 may be formed from a polymer, a metal, and/or any other rigid and/or semi-rigid material.

In certain non-limiting embodiments container 311 may be made from various materials, for example a metal or polymer, and/or any thermally conductive material.

FIG. 3c is a schematic illustration of a top view cross section of an axle with extended blades, according to some embodiments of the current invention.

In some embodiments blades 323 may pivot on a coupling mechanism 322 along an axis parallel to axle 321. In certain non-limiting embodiments, blades 323 may extend vertically along a length of a cavity of a container.

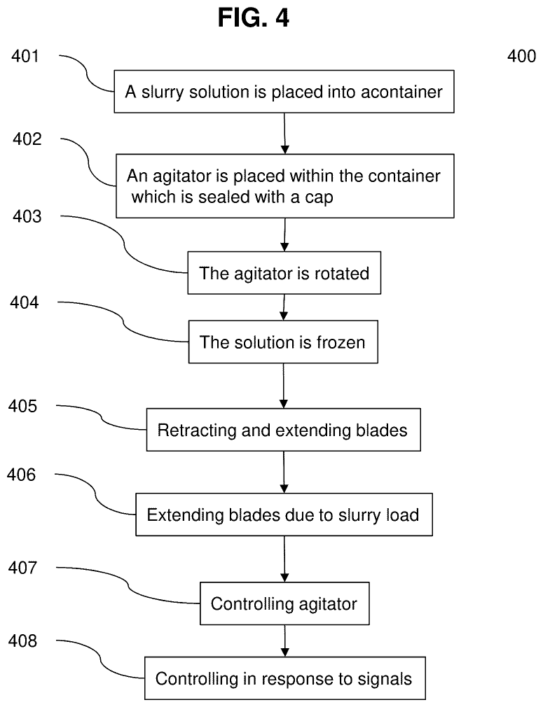

FIG. 4 is a flow diagram detailing a process 400 (method) for making a slushy using the slush maker 200, according to some embodiments of the current invention.

In some embodiments, process 400 begins at a block 401, in which a slurry solution is placed within a container. A slurry solution may comprise any liquid capable of being converted into a slurry mixture, for example a solution of water and sugar.

The process continues with block 402, where an agitator is placed within the container, and the container is sealed with a cap.

The process continues with block 403, where the agitator is rotated.

The process continues with block 404, where the slurry solution is exposed to freezing temperatures.

In some embodiments, the process further comprises at least one of blocks 405 through 408.

In block 405, the agitator is inserted with retracted blades, and the blades are extended within the container to agitate the slurry solution.

In block 406, the blades are extended as a result of force exerted by rotating the blades within the slurry.

In block 407, the rotation of the blades is controlled by a control unit that accepts instructions both from a user interface and from pre-programmed sets of instructions.

In block 408, the control unit receives signals representing physical parameters and/or phenomena from at least one of the slurry, the container, the blades, and/or forces exerted thereon, and a rotation parameter of blades may be changed and/or modified in response to the parameters and/or phenomena.

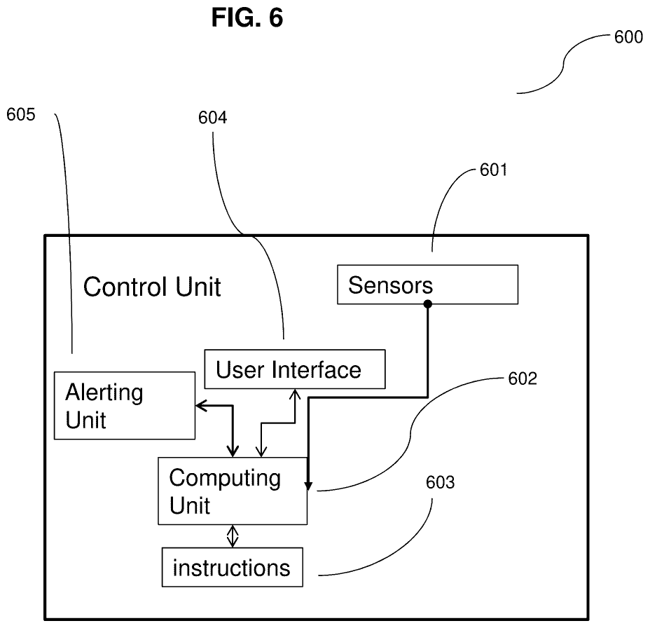

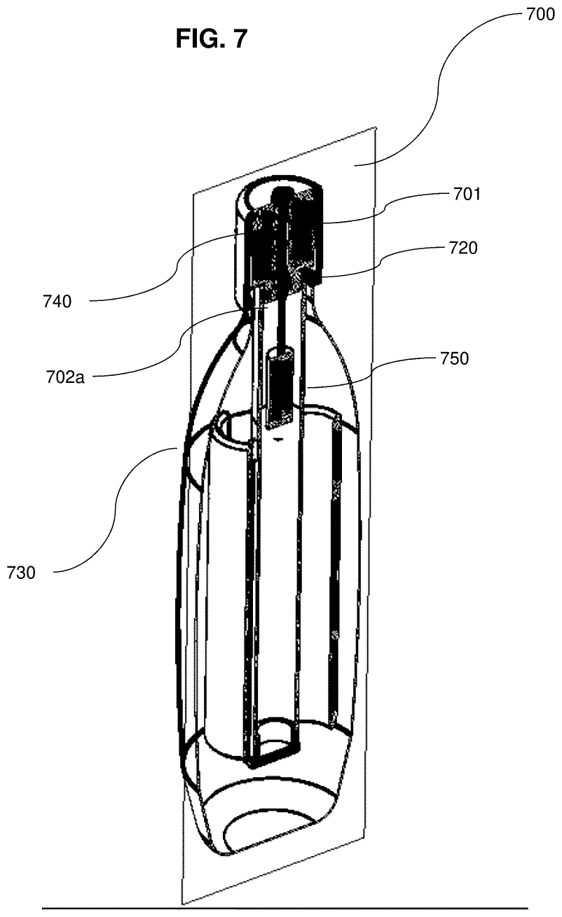

FIG. 6 is a block diagram of a slushy maker control unit 600, according to certain embodiments of the current invention.

In certain embodiments, control unit 600 comprises one or more sensors 601, a computing unit 602, computer readable instructions 603, a user interface 604, and an alerting unit 605. In certain non-limiting embodiments, control unit 600 may be connected directly or indirectly to an electric motor for rotating the agitator, thereby acting as a controller to regulate the speed and/or operation of the motor. In certain non-limiting embodiments, control unit 600 may be programmable, for example with sets of instructions, for example sets of instructions pre-stored in instructions 603 and/or input by a user via user interface 604, as described below. The programming may allow control unit 600 to control rotation of the agitator (not shown). User interface 604 may allow a user to select a program comprising a set of instructions to execute on computing unit 602.

In certain non-limiting embodiments sensors 601 may comprise one or more sensors of one or more types of sensors, including temperature sensor for the contents of the container, temperature sensor of ambient temperature, load sensor to detect resistance of the contents of the container to the rotation of the blades, and/or any other type of sensor. Sensors 601 may transmit encoded signals to computing unit 602 representing parameters and/or physical phenomena, for example temperature of a contents of a container, load and/or resistance of said contents to a rotation of blades, speed of rotation, amount of time of rotation, and/or other parameters and/or physical phenomena.

In certain non-limiting embodiments computing unit 602 may comprise a processor, a computer memory for storing instructions 603 and data, and interfaces to other components of control unit 600 to receive input and to send control signals. In certain non-limiting embodiments computing unit 602 may further comprise a stopwatch, timer, and/or clock function.

Computing unit 602 may comprise a central processing unit (CPU) linked to a memory. The CPU in turn may be linked to components such as an electric motor, relays, and other components of control unit 600. The CPU may be formed of one or more processors, including hardware processors, and performs the processes (methods) of the invention. The memory may store machine-executable instructions executed by the CPU for performing the processes of the invention. Memory, for example, may also provide temporary storage for intermediate computations.

In certain non-limiting embodiments user interface 604 may comprise a mechanical and/or electronic control panel for inputting data, and/or a display screen, for example a touch screen, for display of information. For example, the user interface may allow a user to select a pre-programmed set of instructions that when executed by the computing unit may cause to start, stop, speed up, and/or slow down the rotation of the agitator in response to sensor signals, time, user interface inputs, and/or other inputs.

In certain non-limiting embodiments the user interface may allow a user to input parameters for example a composition of the liquid contents of the container, a desired consistency of the slush, amount of time for the agitator to rotate, and/or any other parameter.

In certain non-limiting embodiments alerting unit 605 may comprise audible, visual, and/or vibrating alert signals, and/or electronic signals, for example alerting by sending a message to a user computing device via a Wi-Fi, Bluetooth, wireless, cellular, LAN, WAN, wired, wireless, and/or any other electronic communication service. In certain non-limiting embodiments alerting unit 605 may alert a user when the contents of the slushy maker have been transformed from liquid to slush.

In certain non-limiting embodiments, computing unit may comprise pre-programmed instructions stored in memory that may be executed by user input to user interface 604. The execution of program instructions may perform a plurality of functions, including but not limited to at least one of the following functions:
1. Begin rotating the agitator when the temperature sensor signals indicate the temperature of the liquid has dropped below a threshold temperature, the threshold may be pre-programmed in memory and/or entered via the user interface.
2. Begin, end, slow down, and/or speed up the rotation of the agitator based on the signals of the load sensor, for example slow down or stop the rotation when the load parameter exceeds a threshold value.
3. Stop and/or start the rotation of the agitator based on elapsed time and/or time of day.
4. Operate the agitator rotation with a duty cycle of on/off time periods.

FIG. 7 is a schematic illustration of a side view cross section of a slushy maker with extended blades, according to embodiments of the present invention.

In certain non-limiting embodiments, cap 701 of slushy maker 700, cooperating with mouth opening 702a may comprise sealing mechanism 720 of container 730, for example correspondingly configured male and female threads for screwing and unscrewing. Cap 701 may be adapted to sealing liquids within container 730. Alternatively and/or additionally, sealing mechanism 720 may comprise a separate mechanism that may removably attach cap 701 to container 730, thereby sealing liquids within container 730. For example sealing mechanism 720 may comprise one or more of a latch, a clip top, wings, a gasket, a click stop, and/or any other mechanism for sealing a container.

In certain non-limiting embodiments, cap 701 may comprise a sealing mechanism to seal liquids within slushy maker 700.

In certain non-limiting embodiments, rotating mechanism 740 may be integrated within cap 301. Optionally, rotating mechanism 740 may be detachable from agitator 750 and/or cap 301.

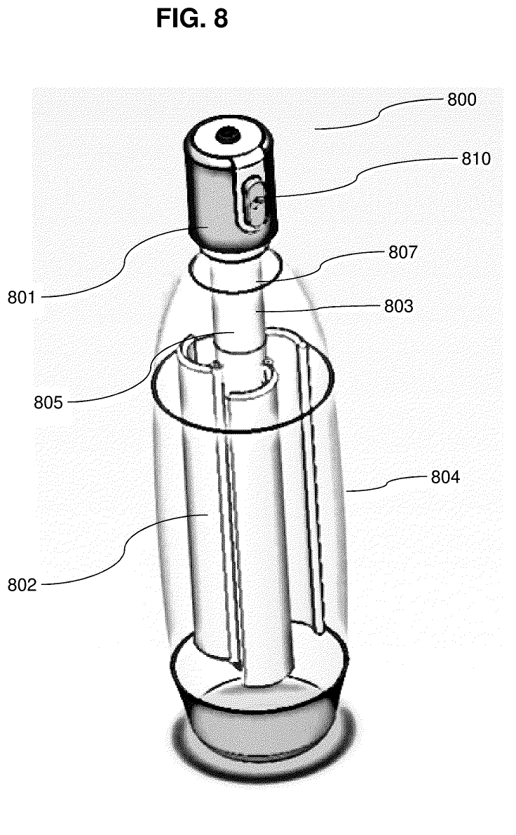

FIG. 8 is a schematic illustration of a transparent side view of a slushy maker with extended blades, according to embodiments of the present invention.

In certain non-limiting embodiments, slushy maker 800 may comprise a control device 810 on cap 801. Control device 810 may be an on/off control, a knob, a slider, a touch screen, and/or a user interface as described in FIG. 6.

In certain non-limiting embodiments, blades 802 may extend towards and/or touch container 804. Agitator 803 may extend within container 804. Blades 802 may be attached to axle 805.

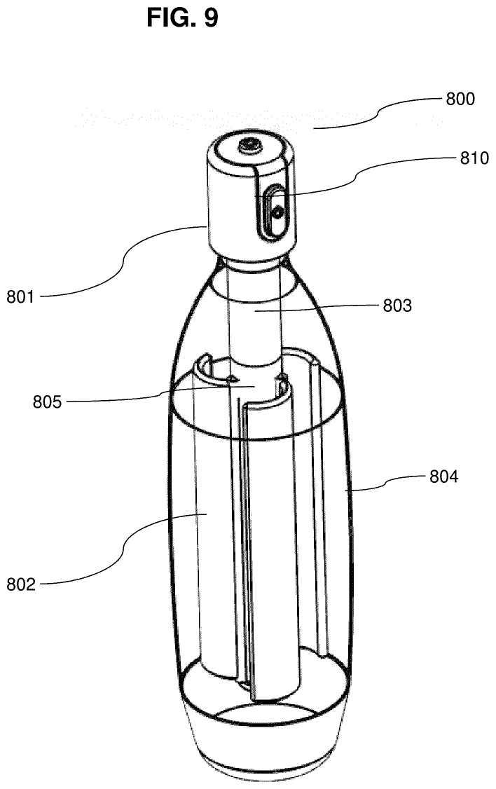

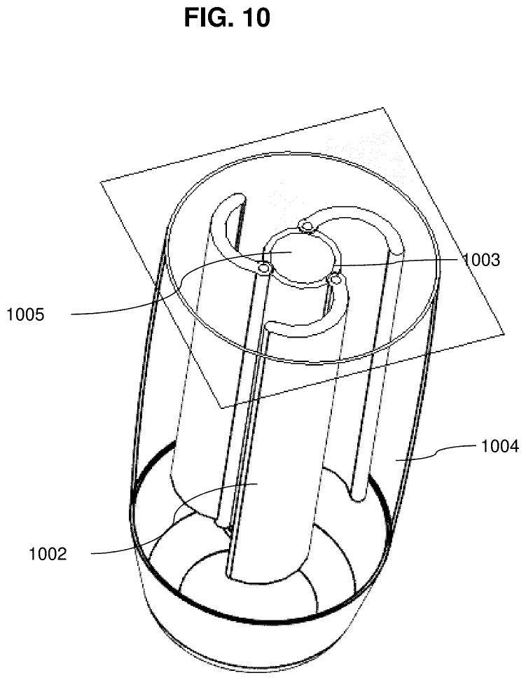

FIG. 9 is a schematic illustration of an outline side view of a slushy maker with extended blades, according to embodiments of the present invention.

In certain non-limiting embodiments, FIG. 9 is a line drawing version of FIG. 8.

FIG. 10 is a schematic illustration of a top view cross section of a slushy maker with extended blades, according to embodiments of the present invention.

In certain non-limiting embodiments, slushy maker 1000 may comprise axle 1005, blades 1002, container 1004, and coupling mechanism 1003.

Implementation of the method and/or devices of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit, or a virtual machine or virtual hardware. As software, selected tasks according to embodiments of the invention could be implemented as a plurality of software instructions being executed by a computer, with or without using any suitable operating system. In an exemplary embodiment of the invention, one or more tasks according to exemplary embodiments of method and/or system as described herein are performed by a data processor, such as a computing platform for executing a plurality of instructions. In certain non-limiting embodiments, the data processor includes a volatile memory for storing instructions and/or data and/or a non-volatile storage, for example, non-transitory storage media such as a magnetic hard-disk and/or removable media, for storing instructions and/or data. In certain non-limiting embodiments, a network connection is provided as well. A screen, display and/or a user input device such as a keyboard or mouse are in certain non-limiting embodiments provided as well.

For example, any combination of one or more non-transitory computer readable (storage) medium(s) may be utilized in accordance with the above-listed embodiments of the present invention. A non-transitory computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable non-transitory storage medium may be any tangible medium that can contain, or store a program for use by or in connection with an instruction execution system, apparatus, or device.

A “computer”, “processor”, “computing unit”, and/or any other term referring to a machine that executes coded instructions, includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smart phone, personal digital assistant (PDA), mobile telephone or cellular telephone).

A “server” is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software based emulation of a computer.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and devices, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments, unless the embodiment is inoperative without those elements.

To the extent that the appended claims have been drafted without multiple dependencies, this has been done only to accommodate formal requirements in 30 jurisdictions which do not allow such multiple dependencies. It should be noted that all possible combinations of features which would be implied by rendering the claims multiply dependent are explicitly envisaged and should be considered part of the invention.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A device for converting a liquid to a slushy mixture comprising;
a container, a cap, and an agitator;
said container comprising an enclosure surrounding an interior cavity, said enclosure comprising a mouth opening providing access to said cavity;
said cap removably attachable to said mouth, said cap comprising a sealing mechanism adapted to seal liquids within said container;
said agitator comprising:
an axle extending from said mouth into said cavity of said container;
at least one blade attached to said axle for agitating a content of said container when said agitator is rotated; and
a rotation mechanism for rotating said axle relative to said container.

2. The device of claim 1, further comprising a coupling mechanism connecting between said axle and said blades, said coupling mechanism allowing said blades to move between an extended state wherein said at least one blades extends radially from said axle towards an outer side of said interior of said container, and a retracted state, wherein said at least one blade retracts away from said outer side and towards said axle.

3. The device of claim 2, wherein a maximum cross-section of said at least one blade and said axle when said blade is in said retracted state is less than an interior cross-section of said mouth, thereby allowing said agitator to pass within said mouth.

4. The device of claim 2, wherein the at least one blade further comprises a protrusion when in said retracted state, such that rotation of said at least one blade will at agitate at least a portion of said content of said container, whereupon said content will exert a force onto said at least one blade in a direction opposite to said rotation.

5. The device of claim 2, further comprising a mechanism that exerts a force to push said at least one blade to said retracted position, and a mechanism that extends said at least one blade towards said extracted position.

6. The device of claim 2, wherein at least one of said at least one blade, when in said extended state and rotating, is in contact with said interior of said container.

7. The device of claim 1, further comprising a programmable control unit adapted to control operation of said rotation of said agitator,

8. The device of claim 7 wherein the control unit further comprises a user interface for inputting instructions, a computing unit for storing and executing said instructions, an alerting unit, a computing unit for controlling rotation of said axle, and sensors for detecting physical phenomena of at least one member of a group comprising said agitator, said container, and said contents,

9. The device of claim 7, wherein the control unit further comprises at least one sensor adapted to detect at least one member of a group of physical phenomena comprising: temperature of said contents, force of resistance of said content to rotation of said at least one blade, speed of said rotation, and amount of time of said rotation, said at least one sensor adapted to transmit an encoded signal representing said detected physical phenomena to said computing unit.

10. The device of claim 8, wherein the control unit further comprises at least one user-selectable program comprising a plurality of instructions to said computing unit to control said rotation of said program instructions responsive to said transmitted encoded signal.

11. The device of claim 1, wherein the rotation mechanism further comprises a battery connected to an electrical motor, said motor adapted to rotate said axle.

12. A method for producing a slushy in a portable container comprising:
placing a slurry solution into a container;
inserting an agitator with at least one blade into a cavity of said container;
sealing said container with a cap
exposing said solution to freezing temperature; and
rotating said agitator.

13. The method of claim 12, further comprising inserting said agitator into said container by retracting said at least one blade towards an axle of said agitator, and agitating said container contents by rotating said at least one blade and extending said at least one blade towards an interior wall of said container.

14. The method of claim 13 further comprising rotating said at least one blade in a retracted state, whereby a protrusion of said blades interacting with said content of said container exerts a force on said at least one blade in a direction opposite to said rotation.

15. The method of claim 13, further comprising retracting and extending said at least one blade by a force generated by a mechanism attached to said blades.

16. The method of claim 13, further comprising when rotating said agitator, scraping an interior surface of said container by a surface of at least one of said at least one blade.

17. The method of claim 12, further comprising controlling said rotation of said agitator by inputting instructions to a control unit of said device, said control unit alerting a user of a state of operation of said device.

18. The method of claim 17, further comprising controlling said operation of said agitator responsive to sensing at least one physical phenomena selected from a group comprising: temperature of said contents, force of resistance of said content to rotation of said at least one blade, speed of said rotation, and amount of time of said rotation.

19. The method of claim 17, further comprising controlling said operation of said agitator responsive to sets of user-selectable programs.
